(19) United States
(12) Patent Application Publication
(10) Pub. No.: US 2026/0195838 A1
(43) Pub. Date: Jul. 9, 2026

(54) SYSTEM AND METHOD FOR AUTOMATED GENERATION OF EXECUTABLE TRAINING SCENARIOS FROM ANONYMIZED REAL-WORLD PROJECT DATA

(71) Applicant: Syed Nauman ABEDI, Hanover, MD (US)

(72) Inventor: Syed Nauman ABEDI, Hanover, MD (US)

(21) Appl. No.: 19/553,607

(22) Filed: Mar. 2, 2026

Related U.S. Application Data
(63) Continuation-in-part of application No. 18/444,519, filed on Feb. 16, 2024, now abandoned.

(51) Int. Cl. G06Q 50/20; G06Q 10/10

(52) U.S. Cl. CPC G06Q 50/2057; G06Q 10/103

(57) ABSTRACT

The present invention relates to a system that ingests real-world project data, automatically anonymizes identifying information using a persistent mapping mechanism, and generates machine-executable decision-making scenarios for scalable, objective professional training. The system for scalable, automated scenario generation from real-world data comprises a computing device having a processor and a memory for storing one or more instructions executable by the processor. The processor is configured to execute a plurality of modules for generating and executing decision-state models derived from real-world project datasets. The plurality of modules comprises a generation module, an anonymization module, a storage module, an assigning module, an evaluation module, and a feedback module. The proposed system converts real-world project data into executable decision-state models using processor-executed scenario generation techniques that preserve contextual constraints, decision states, and project conditions. The proposed system anonymizes completed project data in a privacy-preserving manner by automatically detecting and replacing identifying entities while maintaining internal logical consistency across training scenarios.

### FIELD OF THE INVENTION

The present invention relates generally to computer-implemented systems and methods for automated generation of executable training scenarios, and more particularly, relates to a system that ingests real-world project data, automatically anonymizes identifying information using a persistent mapping mechanism, and generates machine-executable decision-making scenarios for scalable, objective professional training.

### BACKGROUND

Conventional professional training approaches frequently rely on lectures, static digital content, recorded media, quizzes, and pre-authored case studies. While these approaches may be effective for conveying theoretical concepts, they often result in passive learning and do not adequately train individuals to independently identify information gaps, evaluate uncertainty, or make consequential decisions under real-world constraints. In many existing computerized systems, learners are presented with predefined questions or multiple-choice options, which limits the development of applied judgment and decision-making skills.

Various computerized training platforms have attempted to introduce scenario-based learning to increase engagement. For example, US20140220536A1 describes a computerized training and assessment system in which learners interact with instructional scenarios and provide responses that are evaluated against predetermined criteria. Although this approach introduces interactive elements, the disclosed system relies on pre-authored instructional content and structured response formats. The scenarios are not derived from completed real-world project data, and the system does not disclose automated mechanisms for anonymizing sensitive or identifying information from real projects while preserving internal consistency across scenario materials. Further, the system of US20140220536A1 does not provide a computational framework for comparing user-generated decisions with actual real-world decision outcomes associated with completed projects.

U.S. Pat. No. 8,126,838B2 describes simulation-based training systems in which users interact with modeled or virtual environments to practice skills and receive feedback. While such systems may provide immersive simulations, they generally rely on manually designed or abstracted models that represent hypothetical situations rather than training scenarios constructed from real-world completed projects. The systems disclosed in U.S. Pat. No. 8,126,838B2 do not address the technical challenges of ingesting real project data, masking identifying characteristics to prevent project recognition, or maintaining ground-truth decision timelines for objective post-exercise comparison.

In addition, existing training systems, including those described in US20140220536A1 and U.S. Pat. No. 8,126,838B2, typically utilize predefined scenario structures or scripted branching logic. As a result, learner interactions are constrained to anticipated response paths, and scenario progression is not dynamically determined based on semantic evaluation of user-generated inputs. These systems also do not disclose mechanisms for retrospectively identifying unrecognized information gaps by comparing learner assumptions against real-world project data after scenario completion.

Further technical limitations are observed in the scalability and reuse of training content. Many existing systems require extensive manual authoring to create and update scenarios, making it difficult to efficiently reuse training materials across different learner populations or professional domains. Additionally, known systems lack automated architectures capable of executing multiple concurrent instances of complex, decision-driven scenarios while providing consistent and objective evaluation based on real-world outcomes.

Therefore, there is a need for a system that can automatically transform completed real-world project data into anonymized, executable decision-making scenarios; dynamically adapt scenario progression based on learner inputs; and objectively compare learner decisions with real-world decision outcomes to provide repeatable and scalable feedback. Further, there is also a need for a system that addresses the technical limitations of existing training platforms while providing a more realistic and effective approach to professional skill development.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a system that ingests real-world project data, automatically anonymizes identifying information using a persistent mapping mechanism, and generates machine-executable decision-making scenarios for scalable, objective professional training.

According to an aspect, the invention provides a system for scalable, automated scenario generation from real-world data. In one embodiment herein, the system comprises a computing device having a processor and a memory for storing one or more instructions executable by the processor. In one embodiment herein, the system is configured to automatically generate executable decision-state models from heterogeneous project artifacts, thereby reducing manual scenario authoring time. The processor is configured to execute a plurality of modules for generating and executing decision-state models derived from real-world project datasets. The plurality of modules comprises a generation module, an anonymization module, a storage module, an assigning module, an evaluation module, and a feedback module.

In one embodiment herein, the generation module is configured to generate executable decision-state models from source data associated with at least one completed real-world project. Each executable training scenario comprises machine-readable scenario data defining contextual constraints, decision states, and outcome parameters. The generation module employs one or more artificial intelligence (AI) models configured to assist in scenario generation and anonymization under instructor-defined constraints. The generation module is configured to transform the source data into a branching decision graph comprises a plurality of decision nodes and outcome states corresponding to alternative user decision paths. Each branching decision node of the branching decision graph is associated with a timestamped state transition derived from the completed real-world project.

In one embodiment herein, the anonymization module is configured to automatically anonymize identifying entities within the source data by detecting project-specific identifiers across a plurality of heterogeneous source artifacts, generating and storing a persistent mapping table that associates each detected identifier with a corresponding fictitious entity, and replacing the detected identifiers with the fictitious entities according to the mapping table, thereby preserving internal logical and relational consistency across the plurality of heterogeneous source artifacts and generated scenarios. The project-specific identifiers include personal names, geographic locations, organizational identifiers, temporal references, and project-unique identifiers. The mapping table is referenced during generation of multiple different training scenarios from the same source data to ensure cross-scenario identifier consistency. The anonymization module is configured to preserve relational dependencies between the detected project-specific identifiers when replacing the detected project-specific identifiers with the fictitious entities.

In one embodiment herein, the storage module is configured to store the executable decision-state models and associated ground-truth decision data in a data repository. The ground-truth decision data represents structured decision timelines and outcome representations derived from the completed real-world project. The storage module is configured to store versioned instances of the executable decision-state models corresponding to different anonymization profiles, user cohorts, or instructional configurations.

In one embodiment herein, the assigning module is configured to assign at least one of the executable decision-state models to a user via a user-side application and receive user-generated decision inputs during execution of the executable training scenario. The one or more user devices are provided with a user interface that is configured to display the at least one of the executable decision-state models to users while suppressing access to the ground-truth decision data during scenario execution. The user-side application is implemented as at least one of a web application, a mobile application, a learning management system plug-in, or a virtual reality interface.

In one embodiment herein, the evaluation module is configured to execute a comparison operation that maps the user-generated decision inputs to the ground-truth decision data by analyzing decision sequencing, outcome alignment, and consequence propagation. The evaluation module is configured to determine subsequent scenario states during execution based on semantic analysis of the user-generated decision inputs rather than predefined branching logic. The evaluation module compares the user-generated decision inputs by computing at least one of decision order alignment, temporal deviation, outcome variance, or downstream consequence impact relative to the ground-truth decision data. The evaluation module is configured to compute a quantitative performance score based on a weighted comparison of the user-generated decision inputs relative to the ground-truth decision data. The weighted comparison assigns different weights to decision timing accuracy, decision correctness, and downstream outcome impact.

In one embodiment herein, the feedback module is configured to generate feedback data identifying divergence between the user-generated decision inputs and the ground-truth decision data, thereby providing objective and repeatable performance feedback to the one or more user devices. The feedback module is further configured to generate corrective guidance data identifying alternative decision paths that more closely align with the ground-truth decision data. The feedback data is generated after completion of an executable training scenario and is stored for subsequent review by an instructor or administrator user. In one embodiment herein, execution of the generation module, the anonymization module, and the evaluation module is configured to utilize memory-resident graph data structures and indexed mapping tables to perform state transition resolution and identifier substitution using reduced computational redundancy and parallelized processing control, thereby improving processor efficiency, memory utilization, and real-time scenario state determination during execution of the executable decision-state models.

In one embodiment herein, the computing device is communicatively coupled to a server via a network. The computing device is configured to execute multiple instances of the executable decision-state models concurrently across distributed computing resources. In one embodiment herein, the at least one completed real-world project is stored in a database, which is communicatively coupled to the network.

According to another aspect, the invention provides a computer-implemented method for operating the system for scalable, automated scenario generation from real-world data. At one step, the generation module generates the executable decision-state models from the source data associated with the at least one completed real-world project. At one step, the anonymization module automatically anonymizes identifying entities within the source data by detecting the project-specific identifiers and replacing the detected project-specific identifiers with the fictitious entities while preserving the internal logical consistency across the executable decision-state models.

At one step, the storage module stores the executable decision-state models and the associated ground-truth decision data in the data repository. At one step, the assigning module assigns the at least one of the executable decision-state models to the one or more user devices via the user-side application and receives the user-generated decision inputs. At one step, the evaluation module compares the user-generated decision inputs with the ground-truth decision data derived from the completed real-world project. At one step, the feedback module generates the feedback data identifying divergence between the user-generated decision inputs and the ground-truth decision data, thereby providing objective performance feedback to the one or more user devices.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a system for scalable, automated scenario generation from real-world data, in accordance with embodiments of the invention.

FIG. 2 illustrates a flowchart of a computer-implemented method for operating the system for scalable, automated scenario generation from real-world data, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

According to an exemplary embodiment, the invention provides a system 100 that ingests source data associated with at least one completed real-world project, automatically anonymize identifying entities within the source data, generate machine-readable executable decision-making instructional scenarios, and execute the scenarios to provide structured, processor-controlled training for development of profession-relevant skills and knowledge.

In one embodiment herein, the system 100 enables individuals to develop profession-relevant skills through execution of decision-making instructional exercises derived from real-world completed projects. The system 100 converts real-world project data into executable decision-state models using processor-executed scenario generation techniques that preserve contextual constraints, decision states, and project conditions. The system 100 anonymizes completed project data in a privacy-preserving manner by automatically detecting and replacing identifying entities while maintaining internal logical consistency across training scenarios.

In one embodiment herein, the system 100 prevents reverse identification of real-world projects while preserving realism, thereby enabling reuse of well-known projects without exposing outcomes or sensitive information to users. The system 100 provides executable decision-state models that intentionally include incomplete information, requiring users to generate decisions under uncertainty in a manner that computationally mirrors real professional environments. The system 100 enables structured capture and storage of user-generated decision inputs and reasoning data for objective evaluation and retrospective analysis.

In one embodiment herein, the system 100 computationally compares user decisions with ground-truth decisions derived from completed real-world projects. The system 100 generates objective, repeatable feedback identifying divergences between user decisions and real-world outcomes, thereby improving decision quality and outcome awareness. The system 100 supports dynamic scenario progression based on semantic analysis of user inputs rather than fixed branching paths or predefined inflection points. The system 100 reduces manual scenario authoring effort and development time through automated scenario generation and anonymization processes executed by computing systems. The system 100 provides a scalable training architecture capable of concurrently executing multiple training scenarios across distributed client-side computing devices.

In one embodiment herein, the system 100 maintains instructor oversight without displacing human judgment, by providing instructor-specific guidance interfaces while executing core scenario processing and evaluation computationally. The system 100 improves training effectiveness over traditional multiple-choice and scripted systems by enabling users to experience consequences of decisions rather than selecting predefined answers. The system 100 delivers a cost-effective and reusable training solution applicable across multiple professional domains including engineering, medicine, law, management, military, and aviation. The system 100 enhances consistency, objectivity, and repeatability in professional training systems by standardizing scenario execution, anonymization, and decision comparison mechanisms.

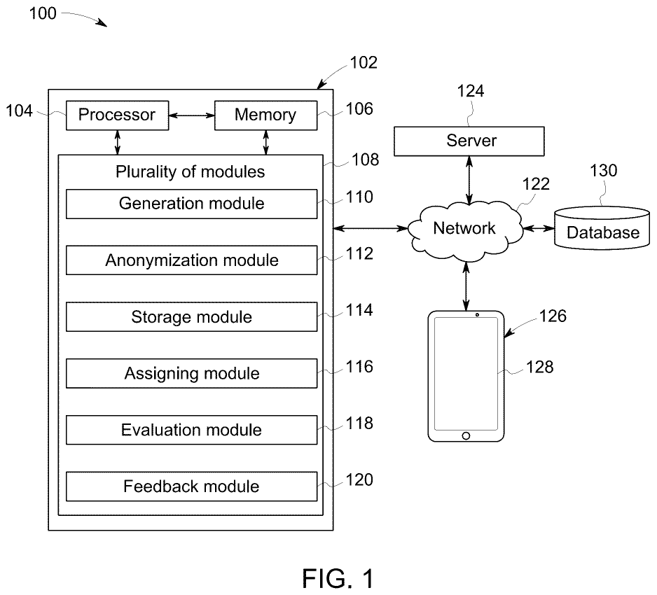

FIG. 1 refers to a system 100 for scalable, automated scenario generation from real-world data. In one embodiment herein, the system 100 comprises a computing device 102 having a processor 104 and a memory 106 for storing one or more instructions executable by the processor 104. The processor 104 is configured to execute a plurality of modules 108 for generating and executing decision-state models derived from real-world project datasets. The plurality of modules 108 comprises a generation module 110, an anonymization module 112, a storage module 114, an assigning module 116, an evaluation module 118, and a feedback module 120.

In one embodiment herein, the generation module 110 is implemented as a processor-executed software component configured to operate within a server-side processing environment and to generate one or more executable decision-state models from the source data associated with at least one completed real-world project. The source data may comprise structured and unstructured project artifacts including event logs, decision records, timelines, communications, resource constraints, and outcome data.

Each executable training scenario generated by the generation module 110 comprises machine-readable scenario data stored in a structured data format, the scenario data defining a plurality of contextual constraints, decision states, and outcome parameters that collectively govern execution of the training scenario by a client-side application. The contextual constraints define operating conditions under which user decisions are evaluated, including temporal constraints, resource limitations, role-specific permissions, and dependency relationships among project elements.

The generation module 110 employs one or more artificial intelligence (AI) models executed by one or more processors to assist in scenario generation and anonymization. The AI models are configured to process the source data under instructor-defined constraints, including permissible scenario length, complexity thresholds, decision density, and anonymization rules. In one embodiment, the AI models generate intermediate scenario representations that are iteratively validated against predefined structural completeness criteria prior to being finalized as executable decision-state models.

The generation module 110 is further configured to transform the source data into a branching decision graph represented as a state-based data structure comprising a plurality of decision nodes and outcome states. Each decision node represents a discrete decision opportunity encountered during execution of the training scenario, while each outcome state represents a subsequent scenario condition resulting from a user-selected decision path. Transitions between decision nodes and outcome states define alternative user decision paths and corresponding downstream consequences.

Each branching decision node within the branching decision graph is associated with a timestamped state transition derived from the completed real-world project. The timestamped state transition encodes a temporal sequence in which the corresponding real-world decision occurred relative to other decisions in the project timeline. The timestamped state transitions enable temporal alignment between user-generated decisions and ground-truth project decisions, thereby facilitating computational comparison of decision sequencing, timing, and outcome impact during post-execution evaluation.

In one embodiment herein, the anonymization module 112 is implemented as a processor-executed software component configured to automatically anonymize identifying entities within the source data associated with a completed real-world project prior to generation or execution of one or more executable decision-state models i.e., executable training scenarios. The anonymization module 112 operates without manual intervention and is configured to prevent reverse identification of the completed real-world project while preserving scenario realism and internal coherence. In one embodiment herein, the anonymization module 112 automatically anonymizes identifying entities within the source data by detecting project-specific identifiers across a plurality of heterogeneous source artifacts, generating and storing a persistent mapping table that associates each detected identifier with a corresponding fictitious entity, and replacing the detected identifiers with the fictitious entities according to the mapping table, thereby preserving internal logical and relational consistency across the plurality of heterogeneous source artifacts and generated scenarios.

As used herein, “heterogeneous source artifacts” refers to diverse, multi-format data files generated during a real-world project, including but not limited to, event logs (system-generated timestamped records), communication records (emails, chat logs, meeting transcripts), timeline data (Gantt charts, project schedules, milestone trackers), resource documents (budget spreadsheets, staffing plans, procurement records), and decision records (meeting minutes, approval forms, change requests).

The anonymization module 112 is configured to detect project-specific identifiers within the source data using one or more entity-detection techniques, including rule-based pattern matching, trained machine-learning models, and contextual analysis. The project-specific identifiers include, but are not limited to, personal names, geographic locations, organizational identifiers, temporal references, communication artifacts, resource identifiers, and project-unique identifiers.

Upon detection of a project-specific identifier, the anonymization module 112 replaces the detected identifier with a fictitious entity selected or generated according to predefined anonymization rules. The anonymization module 112 employs a consistent mapping mechanism to ensure that each detected project-specific identifier is replaced with the same fictitious entity across all portions of the source data and across multiple executable decision-state models derived from the source data. As used herein, the consistent mapping mechanism comprises a processor-executed identifier substitution process that maintains a persistent mapping table associating each detected project-specific identifier with a corresponding fictitious entity, such that repeated occurrences of the same identifier are replaced identically across datasets, scenarios, and execution instances while preserving relational and temporal dependencies.

In one embodiment, the anonymization module 112 generates and stores a mapping table in a non-transitory memory, wherein the mapping table associates each original project-specific identifier with a corresponding fictitious entity. The mapping table is referenced during anonymization to enforce consistent substitution and to prevent divergent replacements of the same identifier within or across executable decision-state models.

The anonymization module 112 is further configured to preserve relational dependencies between detected project-specific identifiers during replacement. Preserving relational dependencies comprises maintaining hierarchical relationships, temporal ordering, organizational associations, and role-based relationships between identifiers. For example, when anonymizing multiple identifiers associated with a single organizational entity, the anonymization module 112 ensures that corresponding fictitious entities reflect consistent organizational relationships and reporting structures.

In one embodiment, the anonymization module 112 applies re-identification risk mitigation logic configured to evaluate whether combinations of anonymized identifiers, temporal references, and contextual constraints could enable reconstruction of the original project identity. If a re-identification risk exceeds a predefined threshold, the anonymization module 112 modifies one or more fictitious entities or contextual attributes while maintaining logical consistency, thereby further reducing the likelihood of reverse identification.

The anonymized source data is generated by the anonymization module 112 is subsequently provided to the generation module for creation of executable decision-state models, ensuring that the training scenarios remain computationally consistent, privacy-preserving, and indistinguishable from fictitious projects to users.

In one embodiment herein, the storage module 114 is implemented as a processor-accessible data management component configured to store and manage executable decision-state models and associated ground-truth decision data within a persistent data repository. The data repository is implemented using one or more non-transitory storage media and may comprise relational databases, object-oriented data stores, graph databases, or distributed storage systems.

The executable decision-state models are stored as machine-readable scenario packages, each package comprising structured scenario data defining contextual constraints, decision states, branching logic, and execution parameters required for scenario runtime execution. The storage module 114 is configured to store metadata associated with each executable training scenario, including scenario identifiers, anonymization profiles, instructional configurations, and compatibility attributes for client-side execution environments.

The ground-truth decision data stored by the storage module 114 represents authoritative decision outcomes derived from the completed real-world project on which the executable decision-state models are based. In one embodiment, the ground-truth decision data comprises structured decision timelines encoding a temporal sequence of real-world decisions, associated decision rationales, intermediate outcomes, and final project results. The ground-truth decision data further includes outcome representations that encode downstream consequences, resource impacts, and dependency resolutions resulting from each real-world decision.

The storage module 114 is further configured to store versioned instances of the executable decision-state models. Each versioned instance corresponds to a distinct configuration state of a training scenario, including variations generated according to different anonymization profiles, user cohorts, difficulty levels, or instructional configurations. The storage module 114 associates each versioned instance with version identifiers, lineage metadata, and configuration parameters to enable controlled retrieval and execution of the appropriate scenario variant.

In one embodiment, the storage module 114 maintains referential links between versioned executable decision-state models and the corresponding ground-truth decision data, enabling consistent comparison of user-generated decision inputs against the correct real-world decision timelines regardless of the anonymization or instructional variant presented to the users. The storage module 114 is further configured to support concurrent access to multiple versioned instances of the executable decision-state models, thereby enabling scalable execution across multiple users and training sessions.

In one embodiment herein, the assigning module 116 is implemented as a processor-executed coordination component configured to assign at least one executable training scenario to one or more users via a user-side application executed on one or more user devices 126. The assigning module 116 is further configured to initiate scenario execution sessions, manage users-scenario associations, and control access to scenario data during runtime execution.

The assigning module 116 retrieves one or more executable decision-state models from the storage module and transmits the executable decision-state models, or references thereto, to the user-side application through a secure communication interface. During execution of the executable training scenario, the assigning module 116 is configured to receive user-generated decision inputs from the user devices 126, including decision selections, action commands, timing information, and optionally associated reasoning data, and to forward the received decision inputs to one or more server-side modules for storage and evaluation.

The one or more user devices 126 executes the user-side application and includes a user interface 128 configured to render the executable training scenario to the user in an interactive format. The user interface 128 is configured to present scenario content, contextual constraints, and decision prompts corresponding to the executable training scenario while suppressing access to ground-truth decision data and outcome representations during scenario execution. Suppressing access comprises restricting display, retrieval, and inference of ground-truth decision data until completion of the executable training scenario or receipt of an authorization signal from a server-side module.

In one embodiment, the user interface 128 enforces runtime access control policies that prevent the user from accessing real-world decision outcomes, solution paths, or instructor-only instructional data during scenario execution, thereby preserving the integrity of user-generated decisions. The assigning module 116 is configured to enforce these access control policies by selectively transmitting only scenario-executable data subsets to the user-side application.

The user-side application executed on the one or more user devices 126 is implemented as at least one of a web-based application, a mobile application, a learning management system (LMS) plug-in, or a virtual reality (VR) interface, each implementation being configured to support interactive scenario execution, input capture, and bidirectional communication with the assigning module 116. The user-side application is further configured to support concurrent execution sessions for multiple users and to maintain session state information associated with each user during scenario execution.

In some embodiments, the user-side application may be implemented using alternative or additional delivery interfaces, including application programming interfaces (APIs), immersive simulation environments, virtual reality systems, or augmented reality systems. Such interfaces enable alternative presentation modalities for executable decision-state models without modification to the underlying anonymization, scenario generation, evaluation, or feedback modules, thereby preserving the technical benefits of the disclosed system 100 across evolving instructional platforms.

In one embodiment herein, the evaluation module 118 is implemented as a processor-executed analytical component configured to execute a comparison operation that computationally maps the user-generated decision inputs received during execution of an executable training scenario to ground-truth decision data derived from a completed real-world project. The evaluation module 118 performs the comparison using structured decision representations stored in a non-transitory memory.

The evaluation module 118 is configured to analyze decision sequencing, outcome alignment, and consequence propagation by mapping user-generated decision inputs to corresponding decision events encoded within the ground-truth decision data. Decision sequencing analysis comprises evaluating the order in which learner decisions are submitted relative to a temporal sequence of real-world decisions stored in a ground-truth decision timeline. Outcome alignment analysis comprises determining whether user-generated decisions lead to outcome states that correspond to, deviate from, or converge with real-world project outcomes.

During execution of the executable training scenario, the evaluation module 118 is further configured to determine subsequent scenario states dynamically based on semantic analysis of the user-generated decision inputs rather than reliance on predefined branching logic. Semantic analysis comprises processing natural-language inputs, structured action selections, or command sequences to infer decision intent and contextual relevance, and selecting a subsequent scenario state that reflects the inferred decision meaning and its projected impact.

In one embodiment herein, the evaluation module 118 is configured to compute one or more decision comparison metrics for evaluating user-generated decision inputs relative to the ground-truth decision data derived from a completed real-world project. The decision comparison metrics include decision order alignment, which represents a correspondence between an ordering of user-generated decisions and an ordering of real-world decisions recorded in a ground-truth decision timeline. The decision comparison metrics further include temporal deviation, which represents a time-based difference between a timing of user-generated decision inputs and a timing of corresponding real-world decisions.

The evaluation module 118 is further configured to compute outcome variance, which represents a divergence between outcomes produced by user-generated decisions and outcomes produced in the completed real-world project. The decision comparison metrics additionally include downstream consequence impact, which represents propagation effects of user-generated decisions on subsequent scenario states, resource utilization, dependency resolution, or project progression within the executable training scenario.

The evaluation module 118 is further configured to compute a quantitative performance score for the user by performing a weighted comparison of the user-generated decision inputs relative to the ground-truth decision data. In one embodiment herein, the quantitative performance score computed by the evaluation module 118 further incorporates positive weighting for correct identification of information gaps present in the scenario content. Information gaps comprise missing facts, unresolved dependencies, unspecified entities, or undefined conditions that materially affect interpretation or decision-making. Users are credited for explicitly identifying such information gaps even when ground-truth resolution is unavailable during scenario execution.

Conversely, negative weighting is applied when users assert unjustified assumptions or conclusions without recognizing the presence of unresolved information gaps. This scoring approach rewards analytical discipline and uncertainty recognition rather than outcome-based guessing, thereby aligning performance evaluation with real-world professional analytical standards. The weighted comparison assigns configurable weighting factors to multiple evaluation dimensions, including decision timing accuracy, decision correctness, and downstream outcome impact, thereby enabling flexible scoring models tailored to different work roles or instructional objectives.

In one embodiment, the weighting factors are adjustable based on instructor-defined parameters or scenario-specific configurations stored in the data repository, allowing the evaluation module 118 to generate performance scores that emphasize different aspects of decision quality without modifying the executable training scenario logic.

In one embodiment herein, the feedback module 120 is implemented as a processor-executed analytical and reporting component configured to generate feedback data that identifies divergence between user-generated decision inputs captured during execution of an executable training scenario and corresponding ground-truth decision data derived from a completed real-world project. The feedback data is generated using comparison results produced by the evaluation module 118 and provides objective, repeatable performance feedback independent of instructor subjectivity.

The feedback module 120 is configured to generate feedback data that includes structured representations of decision divergences, including differences in decision sequencing, timing, outcome alignment, and downstream consequence propagation. In one embodiment herein, the feedback module 120 is further configured to generate a human-readable comparative analysis report that juxtaposes user-generated analytical outputs with corresponding ground-truth analytical representations derived from the completed real-world project. The comparative analysis report presents user interpretations, annotations, and identified information gaps alongside real-world interpretations, verified facts, and resolved ambiguities in a parallelized format, enabling point-by-point comparison of analytical reasoning.

The comparative analysis report further includes explanatory comparison notes identifying specific analytical differences, such as misinterpreted temporal windows, unresolved ambiguity candidates, unverified assumptions, or omitted information gaps. The report is generated after completion of the executable training scenario and is made available to instructor or administrator users through an instructor-side interface for instructional review, discussion, or debriefing purposes. In one embodiment, the feedback data further includes normalized performance metrics, explanatory annotations, and visual indicators representing the magnitude and significance of the identified divergences.

The feedback module 120 is further configured to generate corrective guidance data that identifies one or more alternative decision paths that more closely align with the ground-truth decision data. The corrective guidance data comprises reconstructed decision sequences, recommended timing adjustments, and projected outcome states that would have resulted from selecting decisions consistent with the completed real-world project. In one embodiment, the corrective guidance data is generated by replaying portions of the executable training scenario using ground-truth decision inputs and computing comparative outcome differences.

The feedback module 120 is configured to generate the feedback data and the corrective guidance data after completion of the executable training scenario, thereby ensuring that learner decision-making during scenario execution is not influenced by exposure to real-world outcomes. Upon generation, the feedback data is stored in a non-transitory memory within the data repository and is associated with user identifiers, scenario identifiers, and execution session metadata.

Access to the stored feedback data is controlled via role-based access policies, enabling subsequent review by an instructor or administrator user through an instructor-side or administrator-side interface. The feedback module 120 is further configured to support retrieval, aggregation, and longitudinal analysis of feedback data across multiple executable decision-state models to facilitate performance tracking and instructional assessment.

In one embodiment herein, the computing device 102 is communicatively coupled to a server 124 via a network 122, the network 122 comprising one or more of wired or wireless communication links implemented using Internet Protocol-based communication. The computing device 102 and the server 124 are configured to exchange scenario execution data, user-generated decision inputs, and control signals through secure communication interfaces.

The computing device 102 is further configured to execute multiple instances of executable decision-state models concurrently by leveraging distributed computing resources provided by the server 124. In one embodiment, concurrent execution comprises instantiating independent scenario execution sessions for multiple users, wherein each session maintains an isolated execution state, decision log, and scenario context. The distributed computing resources include one or more server-side processors, virtual machines, containers, or cloud-based execution environments that collectively enable scalable, parallel processing of executable decision-state models without interference between concurrent sessions.

This configuration allows the system to support simultaneous scenario execution for multiple users while maintaining deterministic execution behavior, session isolation, and consistent access to stored scenario data and ground-truth decision data across the distributed computing environment.

In one embodiment, the processor 104 acts as the central processing unit (CPU) of the system 100, responsible for coordinating different tasks and carrying out complex operations, data processing, and decision-making by fetching instructions from the memory 106, thereby decoding the instructions and executing the necessary actions.

In one embodiment herein, the memory 106 serves as the storage component of the system 100, holding the executable instructions, as well as any data or information required by the processor 104 to perform its tasks. The data includes user inputs, system configurations, and any other relevant data needed for the system's operations. Through the communication between the processor 104 and the memory 106, the system 100 is able to process the user inputs, access stored information, perform computations, and make decisions accordingly.

In one embodiment herein, the at least one completed real-world project is stored as project source data within a database 130 implemented on one or more non-transitory storage media. The database 130 is communicatively coupled to the network 122 via one or more network interfaces and is configured to provide controlled, processor-mediated access to the stored project source data by server-side modules of the system 100. The database 130 supports secure retrieval, update, and management of the project source data, including structured and unstructured project artifacts, for use in scenario generation, anonymization, evaluation, and feedback generation operations executed over the network 122.

In one embodiment herein, the system 100 is configured to operate as a digital platform. In one embodiment herein, the system 100 may be implemented in various forms including, but not limited to, a software application installed on the computing device 102, for example, a personal computer or other computing devices, a mobile application designed for smartphones or tablets, and a webpage application (web app) that operates within standard internet browsers. These implementations enable broad accessibility and ensure compatibility with multiple user environments.

In some embodiments, the system 100 is further configured to operate as one or more additional components or interfaces to enhance its utility and integration capabilities. For instance, the system 100 may function as, but is not limited to, a plug-in component and/or a browser extension, conversational artificial intelligence (AI) interface, chatbot, or other digital interaction layer. These interfaces may provide interactive features, including natural language processing (NLP) capabilities, to assist users in interacting with executable decision-state models, submitting decision inputs, requesting contextual information, and receiving system-generated guidance or feedback during or after scenario execution.

In one embodiment herein, the computing device 102 represents any electronic device that a user can utilize to interact with the system 100. The computing device 102 can be, but not limited to, a smartphone, a laptop, a tablet, a personal computer, or any other suitable electronic device. The computing device 102 serves as the user's gateway for accessing and interacting with the system 100. The computing device 102 is configured to enable the user to engage with the system's functionalities and capabilities.

In one embodiment herein, the user interface 128 is a crucial component of the user device 126, which allows the user to input commands, receive information, and control the system 100. The user interface 128 can be, but not limited to, a touch screen, a keyboard, a mouse, voice recognition modules, gesture recognition sensors, and virtual reality interfaces. The versatility of the user interface 128 ensures that the user can engage with the system 100 in a manner that is most intuitive and comfortable for the user, thereby catering to a wide range of user preferences and accessibility needs. The user device 126 empowers the user to interact with the system 100 seamlessly and efficiently by providing multiple user interface options, thereby leveraging the most appropriate input and output modalities for their specific needs and preferences.

In certain embodiments, the system 100 is configured such that execution of the generation module 110, the anonymization module 120, and the evaluation module 150 by the processor 104 utilizes memory-resident graph data structures and indexed mapping tables stored within the memory 106 of the computing device 102 to improve processor efficiency, memory utilization, and real-time scenario state determination.

The generation module 110 constructs and maintains the branching decision graph as an in-memory graph data structure within the memory 106. The branching decision graph comprises interconnected decision nodes and outcome states, each stored as linked data objects including adjacency relationships, timestamp associations, contextual constraints, and state-transition parameters. By maintaining the branching decision graph in the memory 106 during generation and execution of executable decision-state models, repeated disk access and redundant data reconstruction operations are reduced, thereby minimizing input/output latency and improving processor 104 throughput.

The anonymization module 120 generates and maintains the persistent mapping table as an indexed data structure stored in memory 106 and optionally persisted in the data repository. The persistent mapping table includes indexed associations between detected project-specific identifiers and corresponding fictitious entities. In certain embodiments, the mapping table is organized using key-indexed or hash-indexed structures enabling constant-time or near constant-time retrieval of replacement entities during identifier substitution across heterogeneous source artifacts and the branching decision graph. The indexed configuration reduces computational redundancy by preventing repeated identifier resolution and minimizing repeated parsing of previously processed artifacts.

In some implementations, the processor 104 executes identifier detection, substitution, and graph update operations using parallelized processing control, wherein independent source artifacts or independent subgraphs of the branching decision graph are processed concurrently using multiple execution threads or distributed computing resources communicatively coupled via the network 122 to the server 124. Parallel execution of identifier substitution and state propagation reduces cumulative processing latency and improves system scalability when transforming large-scale heterogeneous real-world project datasets.

The evaluation module 150 performs state transition resolution by dynamically traversing the branching decision graph stored in memory 106 in response to user-generated decision inputs received from one or more user devices 126. Subsequent scenario states are determined by referencing pre-associated transition parameters stored within the interconnected decision nodes, thereby avoiding recomputation of state relationships and eliminating repeated reprocessing of the underlying source data during runtime. This memory-resident traversal mechanism enables real-time scenario state determination with reduced computational overhead.

By coordinating execution of the generation module 110, the anonymization module 120, and the evaluation module 150 using memory-resident graph data structures and indexed mapping tables, the system 100 reduces redundant data transformation cycles, limits repeated memory allocation events, and optimizes processor 104 scheduling efficiency. Structured reuse of in-memory data objects further reduces memory fragmentation and improves cache locality during scenario execution.

Accordingly, the system 100 provides a technical improvement in computer-implemented scenario processing by optimizing graph construction, identifier substitution, and state transition resolution within the computing device 102, thereby improving processor efficiency, memory utilization, and real-time execution performance of executable decision-state models derived from heterogeneous real-world project data.

In one embodiment herein, the computing device 102 is in communication with one or more third-party instructional platforms, learning management systems, analytics services, or external data interfaces through the server 124 via the network 122. The network 122 acts as a communication medium that allows the computing device 102 to interact with other components of the system 100, thereby facilitating the exchange of data, commands, and information required for scenario execution, evaluation, feedback generation, and administrative oversight. In one embodiment herein, the network 122 comprises a wireless communication infrastructure that enables flexible and location-independent access to the system 100 by users and administrators.

In one embodiment herein, the network 122 can be, but not limited to, Local Area Network (LAN), Cellular Network, Wide Area Network (WAN), Intranet, Virtual Private Network (VPN), and wireless networks that use radio frequency (RF) or infrared (IR) technology to transmit data without the need for physical cables, thereby providing mobility and flexibility. The versatility of the network 122 ensures that the computing device 102 can seamlessly connect to the third-party travel service interfaces and the server 124 and any authorized third-party instructional or data services, thereby enabling the user to access the system's 100 functionalities and resources from a variety of locations and devices. This wireless connectivity enhances the overall accessibility and convenience of the system 100 for the user. In one embodiment, the third-party travel service interfaces are application programming interface (API).

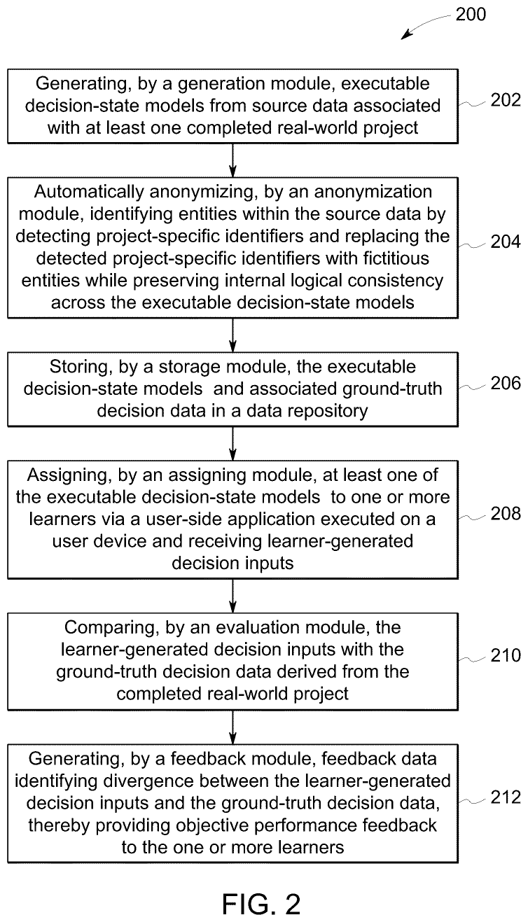

FIG. 2 refers to a flowchart 200 of a computer-implemented method for operating the system 100 for scalable, automated scenario generation from real-world data. At step 202, the generation module 110, executed by one or more processors, generates one or more executable decision-state models by processing source data associated with at least one completed real-world project. The generation module 110 converts the source data into machine-readable scenario data defining contextual constraints, decision states, and outcome parameters suitable for runtime execution.

At step 204, the anonymization module 112, executed by the one or more processors, automatically anonymizes identifying entities within the source data by detecting project-specific identifiers, including personal names, geographic locations, organizational identifiers, temporal references, and project-unique identifiers. The anonymization module 112 replaces the detected project-specific identifiers with fictitious entities using the consistent mapping mechanism that preserves internal logical, relational, and temporal consistency across the executable decision-state models.

At step 206, the storage module 114 stores the executable decision-state models and associated ground-truth decision data in a data repository implemented on one or more non-transitory storage media. The ground-truth decision data comprises structured decision timelines and outcome representations derived from the completed real-world project and is logically linked to the corresponding executable decision-state models.

At step 208, the assigning module 116 assigns at least one of the executable decision-state models to one or more users via a user-side application executed on the one or more user devices 126. During execution of the executable training scenario, the assigning module 116 receives user-generated decision inputs, including decision selections, action commands, and timing information, and forwards the user-generated decision inputs for storage and evaluation.

At step 210, the evaluation module 118 computationally compares the user-generated decision inputs with the ground-truth decision data derived from the completed real-world project. The evaluation module 118 performs the comparison by analyzing at least one of decision sequencing, temporal deviation, outcome alignment, or downstream consequence propagation to determine differences between user decisions and real-world decisions.

At step 212, the feedback module 120 generates feedback data identifying divergence between the user-generated decision inputs and the ground-truth decision data, thereby providing objective, repeatable performance feedback to the one or more users via one or more user devices 126. The feedback data is generated after completion of the executable training scenario and is stored for subsequent review by an instructor or administrator user.

In one embodiment herein, the system 100 executes one or more large language models (LLMs) as processor-executed components operating within a server-side execution environment. The LLMs are accessed through a secured application programming interface (API) or are locally instantiated within a controlled computing environment. The LLMs receive structured prompt data generated by the generation module 110, the anonymization module 112, or the evaluation module 118, where the structured prompt data comprises predefined prompt templates, few-shot examples, formatting constraints, and contextual instructions stored in non-transitory memory.

During execution, user-generated inputs and scenario state data are programmatically combined with the structured prompt data to form session-scoped inference requests that are transmitted to the LLM. The LLM produces structured output data in response to the inference requests, wherein the structured output data conforms to predefined output schemas specifying scenario state updates, feedback content, decision assessments, or anonymized data transformations. The system 100 further includes a post-processing layer configured to validate, normalize, and translate the structured output data into machine-readable scenario state transitions, thereby ensuring deterministic execution behavior independent of free-form natural language generation.

In another embodiment herein, execution of the executable decision-state models, generation of feedback data, and determination of subsequent scenario states are performed entirely by processor-executed artificial intelligence modules without real-time intervention by a human instructor. In this embodiment, the generation module 110, evaluation module 118, and feedback module 120 collectively perform instructional guidance functions by computationally analyzing user-generated decision inputs, selecting responsive scenario content, and generating corrective guidance data using AI models.

Human instructors may optionally review performance data after scenario completion; however, the instructional experience during scenario execution is controlled exclusively by computing systems. This embodiment enables fully automated execution of decision-making instructional scenarios while maintaining objective evaluation, repeatable feedback generation, and scalable deployment across distributed computing environments.

In one embodiment herein, the system 100 further comprises an ambiguity detection mechanism configured to identify unrecognized information gaps and uncertain assumptions associated with user-generated decision inputs. The ambiguity detection mechanism operates by comparing user-generated assumptions, inferred variables, and decision rationales against ground-truth decision data and contextual constraints derived from the completed real-world project.

The ambiguity detection mechanism is configured to generate one or more ambiguity indicators representing missing information, unresolved dependencies, or incorrect assumptions that were not identified by the user during scenario execution. In one embodiment, the ambiguity indicators include confidence scores, uncertainty flags, or annotated information-gap markers that are computed using AI-based semantic analysis or rule-based comparison logic.

The ambiguity indicators are withheld from the user during scenario execution and are selectively revealed after completion of the executable training scenario as part of the generated feedback data. This approach enables retrospective identification of information gaps while preserving authentic decision-making conditions during scenario execution.

In one embodiment herein, the feedback module 120 is further configured to generate post-execution information-gap revelation data identifying additional facts, constraints, or dependencies present in the completed real-world project that were not recognized or requested by the user during scenario execution. The post-execution information-gap revelation data is derived by computationally comparing user-generated decision paths against the complete set of ground-truth project data.

The feedback module 120 selectively presents the post-execution information-gap revelation data after scenario completion to enable users to evaluate how unrecognized information impacted decision outcomes. This delayed disclosure mechanism improves learning effectiveness while preserving the integrity of the decision-making process during scenario execution.

In one embodiment herein, the system 100 is configured to compute and store quantitative technical performance metrics representing operational efficiencies achieved through automated scenario generation and anonymization. The performance metrics include, but are not limited to, scenario generation time, anonymization processing time, entity replacement consistency rates, and reductions in manual authoring effort relative to manually constructed training scenarios.

In one embodiment, the performance metrics indicate that executable decision-state models generated from real-world project data using the system require substantially less processor time and human authoring effort than manually authored scenarios, thereby improving scalability and repeatability of professional training systems. The performance metrics may be stored in the data repository and made available for administrative review, system optimization, or audit purposes.

In one embodiment herein, the generation module 110 provides structured prompt templates to the artificial intelligence models, wherein the structured prompt templates include few-shot examples illustrating desired scenario formats, anonymization patterns, and decision-state representations. The few-shot examples enable consistent generation of executable decision-state models across different real-world projects while reducing variability in AI-generated outputs.

In one example embodiment, executable decision-state models generated by the system 100 may be rendered into non-interactive formats, including printed documents or static digital files, for offline execution. In such embodiments, scenario state transitions, decision points, and outcome disclosures are facilitated by an instructor using precomputed scenario paths derived from the executable scenario data. This embodiment preserves the anonymization, decision-comparison, and feedback principles of the system 100 while enabling training in environments lacking continuous computing connectivity.

In some embodiments, the generation module 110 operates without artificial intelligence (AI) models and instead executes rule-based transformations or expert-authored templates to convert completed project data into executable decision-state models. Artificial intelligence models are optional augmentation components and are not required for generation, anonymization, or evaluation of training scenarios.

During scenario execution, the system 100 captures learner-initiated requests for additional information, uncertainty indicators, or explicitly identified information gaps. These learner-identified gaps are stored as structured data objects and compared against ground-truth project data to determine whether the user appropriately recognized missing or uncertain information. The user-side application is further configured to support multi-learner collaborative sessions in which multiple users submit concurrent or sequential decision inputs, annotations, and arguments. The system 100 records inter-learner decision conflicts and resolution paths as part of the evaluation dataset, enabling assessment of collaborative decision-making effectiveness.

In one embodiment, the system 100 introduces a processor-executed technical improvement over conventional scenario-based training systems by transforming completed real-world project datasets into executable decision-making instructional scenarios through automated anonymization, structural normalization, and scenario generation processes. Unlike traditional scenario-based courses that rely on manually authored hypothetical narratives or predefined question sets, the system 100 ingests real project artifacts and applies computational transformations that preserve causal relationships, decision dependencies, and temporal ordering while preventing reverse identification of the underlying project.

In one embodiment herein, the system 100 is configured to automatically generate executable decision-state models from heterogeneous project artifacts, thereby reducing manual scenario authoring time. The anonymization performed by the system 100 is not limited to redaction or obfuscation of identifying information, but instead comprises automated detection of project-specific identifiers and consistent substitution using fictitious entities across heterogeneous project artifacts, including documents, timelines, communications, and decision records. By enforcing consistent entity replacement and preserving relational dependencies between identifiers, the system 100 maintains internal logical coherence across executable decision-state models while rendering the source project computationally unrecognizable to users.

This technical approach enables generation of executable instructional scenarios that reflect real-world operational complexity without exposing sensitive project information. The resulting scenarios provide users with decision environments that are computationally derived from actual project data rather than authored abstractions, thereby enabling objective comparison between user-generated decisions and ground-truth decision outcomes derived from completed real-world projects. These capabilities are not achievable using traditional scenario-based training systems that rely on static, manually authored instructional content.

In one example deployment, the system 100 is used to generate and execute a plurality of executable decision-state models derived from anonymized real-world project data, where the plurality of scenarios comprised multiple analytical decision-making exercises of increasing complexity and duration. In this deployment, an initial executable training scenario is configured with a reduced number of decision nodes and contextual constraints to familiarize users with scenario execution and decision input formatting, while subsequent executable decision-state models incorporated progressively higher decision density, extended temporal sequences, and increased downstream consequence propagation.

The executable decision-state models are deployed in both online and in-person instructional environments, with concurrent execution sessions supporting groups of approximately 12 to 16 users per session. Across multiple deployments, over 300 individual users are executed the executable decision-state models generated by the system 100, resulting in the capture of structured user-generated decision inputs suitable for automated evaluation, comparison, and feedback generation by the evaluation module 118.

In this example deployment, executable decision-state models are rendered using document-based and spreadsheet-based execution environments, including non-interactive file formats. Despite the absence of real-time interactive simulation interfaces, the system 100 preserved core technical functionality, including consistent anonymization of real-world project data, structured scenario execution, computational comparison of user decisions with ground-truth decision timelines, and post-execution feedback generation. This deployment demonstrates that the disclosed architecture is platform-agnostic and operable across multiple delivery environments without modification to the underlying anonymization, generation, or evaluation modules.

In one embodiment, the system 100 is further configured to compute and store quantitative technical performance metrics representing operational efficiencies achieved through automated scenario generation and anonymization. In observed operation, executable decision-state models generated from completed real-world project datasets required substantially reduced manual authoring effort relative to traditionally scripted scenario-based exercises of comparable complexity, with scenario development time reduced by approximately half or more.

The anonymization module 112 demonstrated consistent replacement of detected project-specific identifiers across multiple executable decision-state models derived from a single project dataset, thereby enabling reliable cross-scenario comparison of user decision outcomes while preventing reverse identification of the underlying real-world project. The system 100 further enabled reuse of anonymized project datasets across multiple training sessions and user cohorts without re-authoring scenario content, thereby improving scalability and repeatability of professional training operations.

The captured performance metrics and deployment characteristics demonstrate that the disclosed system 100 achieves technical effects including reduced scenario development time, improved reuse of real-world project data, consistent anonymization across heterogeneous source artifacts, and objective computational evaluation of user decision-making behavior, none of which are achievable using conventional scenario-based training systems reliant on manually authored instructional materials.

In one example embodiment herein, the system 100 further improves professional training by enabling users to experience the organizational, interpersonal, and downstream human impacts of decisions made under uncertainty. By revealing consequences only after decision execution, the system 100 encourages empathetic reasoning, accountability, and awareness of decision externalities without reducing the training process to predefined responses.

In one embodiment herein, execution of the executable decision-state models is performed using document-based delivery formats rather than interactive software interfaces. In this embodiment, the generation module 110 generates executable training scenario data that is rendered into static digital documents, including word-processing documents and spreadsheet files. The rendered documents comprise scenario content corresponding to an initial scenario state and are distributed to one or more users for offline or instructor-mediated execution. Although the documents are non-interactive, the underlying scenario structure, anonymization logic, ground-truth decision data, and evaluation criteria are precomputed and stored by the system prior to distribution.

In this embodiment, an instructor acts as a controlled execution facilitator rather than a scenario author. Users independently analyze the document-based scenario content and generate decision inputs in the form of annotations, comments, inferred interpretations, and identified information gaps. The instructor aggregates the user-generated decision inputs during a live or asynchronous session and subsequently triggers disclosure of a ground-truth scenario state generated from completed real-world project data. The system 100 compares the user-generated decision inputs with the ground-truth scenario state to generate divergence feedback, thereby preserving the technical evaluation, anonymization, and comparison functionality of the system despite the use of static document-based delivery formats.

In one embodiment herein, user-generated decision inputs are not limited to predefined selections or commands, but comprise free-form analytical annotations applied to scenario content. In one embodiment herein, the user-generated decision inputs further comprise structured analytical annotations applied by the user to scenario content during execution of an executable training scenario. The structured analytical annotations are categorized into predefined annotation types representing distinct analytical functions, including inferred or implied interpretations, background knowledge references, general analytical commentary, and explicitly identified information gaps. Each annotation type is captured as a discrete data object associated with a corresponding portion of the scenario content and is stored with temporal and contextual metadata identifying when and why the annotation was generated.

The evaluation module 118 is configured to independently process each category of structured analytical annotations to assess analytical rigor, ambiguity recognition, contextual awareness, and information-gap identification exhibited by the user. By distinguishing between inferred interpretations, background knowledge assertions, general comments, and identified information gaps, the system enables fine-grained evaluation of how users interpret incomplete or ambiguous information rather than evaluating correctness solely based on final conclusions.

The analytical annotations include inferred meanings, background knowledge references, ambiguity flags, information-gap identifications, and general analytical comments. The annotations may be expressed using structured tags, unstructured natural-language text, or a combination thereof, and may be captured as inline comments, metadata fields, or separate annotation objects associated with specific portions of the scenario content. The evaluation module 118 is configured to semantically analyze the analytical annotations to determine inferred assumptions, identified uncertainties, and decision reasoning paths employed by the user. The semantic analysis enables evaluation of how users interpret incomplete or ambiguous information, rather than evaluating correctness solely based on predefined answers.

In one embodiment herein, each executable training scenario comprises a plurality of scenario states representing progressive analytical stages. The plurality of scenario states includes an initial scenario state corresponding to a “before analysis” representation derived from anonymized real-world project data, a user-modified scenario state corresponding to a “student analysis” representation augmented with user-generated decision inputs, and a ground-truth scenario state corresponding to a “real-life analysis” representation derived from completed real-world project outcomes.

The evaluation module 118 performs state-based comparison operations between the user-modified scenario state and the ground-truth scenario state to identify divergences in inferred meaning, temporal interpretation, ambiguity resolution, and identified information gaps. The state-based comparison enables objective assessment of analytical reasoning quality while preserving authentic decision-making conditions during scenario execution.

In one embodiment herein, the evaluation module 118 includes an ambiguity detection mechanism configured to identify scenario elements that support multiple valid interpretations based on available information. The ambiguity detection mechanism identifies ambiguous references, pronouns, temporal expressions, hierarchical references, language discourses and relational descriptors within the scenario content and evaluates whether users appropriately recognize and preserve multiple plausible interpretations rather than prematurely converging on a single assumption.

In one embodiment herein, when the ambiguity detection mechanism determines that multiple interpretations of a scenario element are simultaneously consistent with available scenario information and contextual constraints, the evaluation module 118 records each such interpretation as a valid analytical hypothesis. In such cases, the evaluation module 118 refrains from penalizing users for maintaining multiple alternative interpretations and instead evaluates whether the user appropriately recognized the existence of ambiguity and avoided premature assumption closure.

Divergence feedback is generated only when a user fails to recognize ambiguity despite insufficient information for resolution, or when the user asserts a singular interpretation that conflicts with verified ground-truth constraints. This approach preserves authentic real-world analytical conditions in which incomplete or ambiguous information may legitimately support multiple plausible interpretations. When multiple interpretations are consistent with the available scenario information, the evaluation module 118 records parallel hypothesis representations and does not penalize users for maintaining alternative interpretations. Divergence feedback is generated only when user-generated interpretations conflict with verified ground-truth constraints or when ambiguity recognition is omitted despite insufficient information for resolution.

In one embodiment herein, the evaluation module 118 is configured to perform temporal inference analysis by identifying implicit time windows, sequencing constraints, and temporal dependencies embedded within the scenario content. The temporal inference analysis includes determining inferred time ranges based on message timestamps, contextual language, and real-world operational constraints associated with the completed project. The evaluation module 118 compares inferred temporal interpretations generated by users with ground-truth temporal data derived from the completed real-world project to identify deviations in timing assumptions, sequencing order, or event alignment. Temporal deviations are incorporated into divergence metrics generated by the feedback module.

In one embodiment herein, the evaluation module 118 is further configured to perform verification operations by referencing external data sources associated with the completed real-world project. In one embodiment herein, the evaluation module 118 is further configured to assess whether users appropriately identify the need for external verification steps when analyzing scenario content that includes geographic, temporal, or contextual uncertainty. The evaluation module 118 records whether user-generated decision inputs include explicit recognition of verification requirements, such as consulting mapping data, geographic databases, authoritative reference sources, or domain-specific repositories to validate inferred assumptions.

Failure to recognize the need for verification in the presence of conflicting or ambiguous information is recorded as an analytical omission, while correct identification and execution of verification steps is recorded as positive analytical behavior. The results of such verification-aware evaluation are incorporated into divergence metrics and performance scoring generated by the feedback module 120. The external data sources include geographic databases, mapping data, authoritative reference datasets, and domain-specific repositories. Verification operations are used to confirm or eliminate alternative interpretations identified during user analysis, including geographic proximity, entity uniqueness, and contextual feasibility. Results of the verification operations are incorporated into the ground-truth scenario state and are used by the evaluation module 118 to assess whether users appropriately validated assumptions or failed to identify verification steps that materially affect scenario interpretation.

In one example embodiment, an executable training scenario is generated from anonymized intelligence communication data derived from a completed real-world project. The initial scenario state comprises a textual message containing ambiguous references, incomplete location data, and implicit temporal information. Users analyze the message and generate analytical annotations identifying inferred meanings, ambiguity candidates, and information gaps.

The evaluation module 118 detects multiple valid interpretations of ambiguous pronoun references and records whether users preserved alternative hypotheses. The evaluation module 118 further performs temporal inference analysis to determine whether users correctly inferred an implicit time window based on message metadata. The ground-truth scenario state incorporates verified geographic data and validated temporal constraints derived from the completed project. The feedback module 120 generates divergence feedback identifying missed ambiguity recognition and unvalidated assumptions, thereby enabling objective post-execution learning without revealing ground-truth outcomes during scenario execution.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for scalable, automated scenario generation from real-world data, comprising:
a computing device having a processor and a memory for storing one or more instructions executable by the processor,
wherein the computing device is communicatively coupled to a server via a network,
wherein the system is configured to automatically generate executable decision-state models from heterogeneous real-world project data, thereby reducing manual scenario authoring time, and wherein the processor is configured to execute a plurality of modules for generating and executing decision-state models derived from real-world project datasets,
wherein the processor is configured to:
generate, via a generation module, executable decision-state models from source data associated with at least one completed real-world project, wherein each executable training scenario comprises machine-readable scenario data defining contextual constraints, decision states, and outcome parameters and further comprising a branching decision graph having interconnected decision nodes and outcome states corresponding to alternative user decision paths;
automatically anonymize, via an anonymization module, identifying entities within the source data by:
detecting project-specific identifiers across a plurality of heterogeneous source artifacts using structured identifier recognition processing;
generating and storing in memory a persistent mapping table that associates each detected identifier with a corresponding fictitious entity; and
replacing the detected identifiers with the fictitious entities according to the persistent mapping table while preserving internal logical and relational consistency across the plurality of heterogeneous source artifacts and the branching decision graph, thereby maintaining referential integrity during execution of the executable decision-state models;
store, via a storage module, the executable decision-state models and associated ground-truth decision data in a structured data repository, wherein the ground-truth decision data represents structured decision timelines and outcome representations derived from the completed real-world project;
assign, via an assigning module, at least one of the executable decision-state models to one or more user devices via a user-side application and receive user-generated decision inputs during execution of the executable training scenario;
execute, via an evaluation module, a state-aware comparison operation that maps the user-generated decision inputs to the ground-truth decision data by analyzing decision sequencing, outcome alignment, and consequence propagation across the branching decision graph and dynamically determining subsequent scenario states during execution based on semantic analysis of the user-generated decision inputs; and
generate, via a feedback module, feedback data identifying divergence between the user-generated decision inputs and the ground-truth decision data using structured deviation computation, thereby providing objective and repeatable performance feedback to the one or more user devices,
wherein execution of the generation module, the anonymization module, and the evaluation module is configured to utilize memory-resident graph data structures and indexed mapping tables to perform state transition resolution and identifier substitution using reduced computational redundancy and parallelized processing control, thereby improving processor efficiency, memory utilization, and real-time scenario state determination during execution of the executable decision-state models.

2. The system of claim 1, wherein the project-specific identifiers include personal names, geographic locations, organizational identifiers, temporal references, and project-unique identifiers.

3. The system of claim 1, wherein the evaluation module is configured to determine subsequent scenario states during execution based on semantic analysis of the user-generated decision inputs rather than predefined branching logic.

4. The system of claim 1, wherein the computing device is configured to execute multiple instances of the executable decision-state models concurrently across distributed computing resources.

5. The system of claim 1, wherein the one or more user devices are provided with a user interface that is configured to display the at least one of the executable decision-state models while suppressing access to the ground-truth decision data during scenario execution.

6. The system of claim 1, wherein the mapping table is referenced during generation of multiple different training scenarios from the same source data to ensure cross-scenario identifier consistency.

7. The system of claim 1, wherein the user-side application is implemented as at least one of a web application, a mobile application, a learning management system plug-in, or a virtual reality interface.

8. The system of claim 1, wherein the evaluation module compares the user-generated decision inputs by computing at least one of decision order alignment, temporal deviation, outcome variance, or downstream consequence impact relative to the ground-truth decision data.

9. The system of claim 1, wherein the generation module employs one or more artificial intelligence (AI) models configured to assist in scenario generation and anonymization under instructor-defined constraints, and
wherein the generation module is configured to transform the source data into a branching decision graph comprises a plurality of decision nodes and outcome states corresponding to alternative user decision paths.

10. The system of claim 9, wherein each branching decision node of the branching decision graph is associated with a timestamped state transition derived from the completed real-world project.

11. The system of claim 1, wherein the at least one completed real-world project is stored in a database, which is communicatively coupled to the network.

12. The system of claim 1, wherein the anonymization module is configured to preserve relational dependencies between the detected project-specific identifiers when replacing the detected project-specific identifiers with the fictitious entities.

13. The system of claim 1, wherein the storage module is configured to store versioned instances of the executable decision-state models corresponding to different anonymization profiles, user cohorts, or instructional configurations.

14. The system of claim 1, wherein the evaluation module is configured to compute a quantitative performance score based on a weighted comparison of the user-generated decision inputs relative to the ground-truth decision data.

15. The system of claim 14, wherein the weighted comparison assigns different weights to decision timing accuracy, decision correctness, and downstream outcome impact.

16. The system of claim 1, wherein the feedback module is further configured to generate corrective guidance data identifying alternative decision paths that more closely align with the ground-truth decision data.

17. The system of claim 1, wherein the feedback data is generated after completion of an executable training scenario and is stored for subsequent review by an instructor or administrator user.

18. A computer-implemented method for operating a system for generating and executing decision-state models derived from real-world project datasets, comprising:
generating, by a generation module, executable decision-state models from source data associated with at least one completed real-world project;
automatically anonymizing, by an anonymization module, identifying entities within the source data by detecting project-specific identifiers and replacing the detected project-specific identifiers with fictitious entities while preserving internal logical consistency across the executable decision-state models;
storing, by a storage module, the executable decision-state models and associated ground-truth decision data in a data repository;
assigning, by an assigning module, at least one of the executable decision-state models to one or more user devices via a user-side application and receiving user-generated decision inputs;
comparing, by an evaluation module, the user-generated decision inputs with the ground-truth decision data derived from the completed real-world project; and
generating, by a feedback module, feedback data identifying divergence between the user-generated decision inputs and the ground-truth decision data, thereby providing objective performance feedback to the one or more user devices.

19. The method of claim 18, wherein the project-specific identifiers include personal names, geographic locations, organizational identifiers, temporal references, and project-unique identifiers.

20. The method of claim 18, wherein the evaluation module is configured to determine subsequent scenario states during execution based on semantic analysis of the user-generated decision inputs rather than predefined branching logic.
